(19) United States
(12) Patent Application Publication
(10) Pub. No.: US 2024/0199237 A1
(43) Pub. Date: Jun. 20, 2024

(54) LAUNCH SYSTEM AND METHOD

(71) Applicant: ISRAEL AEROSPACE INDUSTRIES LTD., Lod (IL)

(72) Inventor: Aharon Yifrach, Ashkelon (IL)

(21) Appl. No.: 17/909,824

(22) PCT Filed: Apr. 5, 2021
(86) PCT No.: PCT/IL2021/050383

§ 371 Date: Sep. 7, 2022

(30) Foreign Application Priority Data
Mar. 12, 2020 (IL) 273270

(51) Int. Cl. B64G 1/00; B64C 30/00; B64D 5/00; B64G 1/64; F02K 7/14; F02K 7/18

(52) U.S. Cl. CPC B64G 1/005; B64C 30/00; B64D 5/00; B64G 1/641; B64G 1/645; F02K 7/14; F02K 7/18

(57) ABSTRACT

A launch system is provided, including a composite vehicle and a carrier vehicle. The composite vehicle includes a payload vehicle, a booster vehicle and a first coupling system. The payload vehicle is configured for powered spaceflight at least in a space medium, and includes a rocket driven propulsion system. The booster vehicle is configured for powered supersonic/hypersonic aerodynamic flight, includes a ramjet propulsion system, and is configured for transporting the composite vehicle between a first altitude and a second altitude under propulsive power provided by the ramjet propulsion system. The first coupling system is configured for selectively coupling and decoupling the payload vehicle with respect to the booster vehicle. The carrier vehicle is configured at least for powered subsonic/transonic/supersonic aerodynamic flight, and for transporting the composite vehicle to at least the first altitude from a ground location. The launch system also includes a second coupling system for selectively coupling and decoupling the composite vehicle with respect to the carrier aircraft.

### TECHNOLOGICAL FIELD

The presently disclosed subject matter relates to launch systems and launch methods for delivering a payload to a high altitude.

### BACKGROUND

Transporting payloads to high altitudes, including to the edge of space and beyond to outer space, conventionally incurs large economic costs, and many attempts at reducing such costs have been tried over the years.

Traditionally, multi-stage rockets, have been used for such purpose, and a large proportion of the associated launch costs has been attributable to the configuration of such launch vehicles, in which the various stages thereof are designed to be discarded soon after their fuel is used up or the stage is decoupled from the next upper stage.

The US Space Shuttle was conceived as a reusable launch system, and the delivery cost per Kg of payload to low earth orbit via Space Shuttle at the beginning of the 1980's reduced previous launch costs to about $85,000 per Kg payload, coming down to about $27,000 per Kg payload by the mid 1990's.

By 2017 the Falcon 9 system, in which the first stage is capable of landing and can be re-used, enables the launch costs to be managed at about $1,900 per Kg.

Other launch systems under development include the LauncherOne system and the Electron system. The LauncherOne system is a two stage orbital launch vehicle, powered by rocket engines and designed to launch payloads of about 300 Kg into Sun-synchronous orbit following deployment from a carrier aircraft at high altitude, with expected launch costs of under US$12,000,000. The Electron system is a two stage orbital launch vehicle, powered by liquid rocket engines and designed to launch payloads of about 150 Kg into Sun-synchronous orbit from the ground, with expected launch costs of under US$5,000,000.

### GENERAL DESCRIPTION

According to a first aspect of the presently disclosed subject matter there is provided a composite vehicle comprising:
a payload vehicle configured for powered spaceflight at least in a space medium, comprising a rocket driven propulsion system;
a booster vehicle configured for powered supersonic/hypersonic aerodynamic flight, comprising a ramjet propulsion system, and configured for transporting the composite vehicle between a first altitude and a second altitude under propulsive power provided by said ramjet propulsion system;
a first coupling system for selectively coupling and decoupling the payload vehicle with respect to the booster vehicle.

For example, said ramjet propulsion system comprises at least one of: a pure ramjet engine; a solid fuel integrated rocket ramjet engine (SFIRR); a scramjet engine; a dual mode ramjet/scramjet (DMRJ).

Additionally or alternatively for example, said booster vehicle has an absence of a turbojet-based propulsion system or a turbofan based propulsion system.

Additionally or alternatively for example, the booster vehicle comprises an aerodynamic wing system configured for providing lift, stability and control to at least the composite vehicle at least at supersonic/transonic conditions between the first altitude and the second altitude. For example, said aerodynamic wing system comprises a delta wing, or, said aerodynamic wing system comprises any one of: variable geometry wings; double delta wings; swept wings. Additionally or alternatively for example, said aerodynamic wing system comprises a vertical stabilizer arrangement including at least one fin pivotable between a stowed position and a deployed position, wherein in the stowed position in which the at least one fin has a first height dimension, and wherein in the deployed position in which the at least one fin has a second height dimension said second height dimension being greater than said first height dimension. For example, in in the deployed position the at least one fin is configured for generating stability and control moments to at least the composite vehicle. Additionally or alternatively for example, said booster vehicle comprises a fuselage, and said at least one fin is pivotably mounted to said fuselage, or, said booster vehicle comprises said aerodynamic wing system, and said at least one fin is pivotably mounted to said aerodynamic wing system.

Additionally or alternatively for example, said aerodynamic wing system comprises a vertical stabilizer arrangement including at least one fin fixedly mounted to the booster vehicle.

Additionally or alternatively for example, said rocket propulsion system comprises at least one of: a solid fuel rocket engine; a liquid fuel rocket engine.

Additionally or alternatively for example, said payload vehicle has an absence of any one of: a ramjet based propulsion system; a turbojet based propulsion system; a turbofan based propulsion system.

Additionally or alternatively for example, said payload vehicle comprises a payload vehicle payload bay configured for accommodating therein a payload.

Additionally or alternatively for example, said first coupling system is configured for coupling the payload vehicle with the booster vehicle in longitudinal stacked arrangement, in which at least a forward part of the payload vehicle is longitudinally forward with respect to the booster vehicle. Alternatively for example, said first coupling system is configured for coupling the payload vehicle with the booster vehicle in transverse stacked arrangement, in which at least a first part of the payload vehicle is in transverse overlying relationship with respect to the booster vehicle. Alternatively for example, said booster vehicle comprises a booster vehicle payload bay, and wherein said first coupling system is configured for coupling the payload vehicle with respect to the booster vehicle payload bay.

Additionally or alternatively for example, the payload vehicle is configured for transporting the composite vehicle at least between the second altitude and a desired altitude under propulsive power provided by said rocket propulsion system, the desired altitude being higher than the second altitude.

Additionally or alternatively for example, said first altitude is the range between 10,000 m and 20,000 m.

Additionally or alternatively for example, said second altitude is the range between 30,000 m and 40,000 m.

Additionally or alternatively for example, said desired altitude is greater than 40,000 m.

According to a second aspect of the presently disclosed subject matter there is provided a launch system, comprising:
the composite vehicle as defined herein according to the first aspect of the presently disclosed subject matter;
a carrier vehicle configured at least for powered subsonic/transonic/supersonic aerodynamic flight, and configured for transporting said composite vehicle to at least said first altitude from a ground location;
a second coupling system for selectively coupling and decoupling the composite vehicle with respect to the carrier aircraft.

For example, said carrier vehicle is a subsonic aircraft or a supersonic aircraft.

Additionally or alternatively for example, said second coupling system is configured for coupling the composite vehicle with the carrier vehicle in transverse stacked arrangement, in which the carrier vehicle is in at least partial transverse overlying relationship with respect to the composite vehicle.

Alternatively for example, said second coupling system is configured for coupling the composite vehicle with the carrier vehicle in said transverse stacked arrangement, in which the carrier vehicle comprises a carrier aircraft fuselage and the second coupling system is configured for selectively coupling and decoupling the composite vehicle directly with respect to a lower portion of the carrier aircraft fuselage. For example, the composite air vehicle has a height dimension, when coupled to the carrier vehicle, less than the fuselage ground clearance of the carrier vehicle. For example, said carrier vehicle is a Boeing 747 type aircraft.

Alternatively for example, said second coupling system is in the form of a wing pylon affixed to a port wing or a starboard wing of the carrier vehicle, and configured for coupling the composite vehicle with the carrier vehicle via the wing pylon. For example, said carrier vehicle is a Boeing 747 type aircraft, and said wing pylon is mounted to the port wing thereof at attached to anchor points on the underside of the port wing.

Alternatively for example, the carrier vehicle comprises two fuselages, each having an outboard wing, and further comprising an interconnecting wing interconnecting the two fuselages, and wherein said second coupling system is in the form of a wing pylon affixed to the interconnecting wing, and configured for coupling the composite vehicle with the carrier aircraft via the wing pylon. For example, said second coupling system is configured for coupling the composite vehicle with the carrier aircraft in transverse stacked arrangement, in which the composite vehicle is in at least partial transverse overlying relationship with respect to the carrier aircraft.

Alternatively for example, said second coupling system is configured for coupling the composite vehicle with the carrier vehicle in said transverse stacked arrangement, in which the carrier vehicle comprises a carrier aircraft fuselage and the second coupling system is configured for selectively coupling and decoupling the composite vehicle directly with respect to an upper portion of the carrier aircraft fuselage.

Alternatively for example, said carrier vehicle is in the form of a rocket booster, configured for propelling the composite vehicle to at least said first altitude from the ground location. For example, the second coupling system is configured for coupling the composite vehicle with the carrier vehicle in transverse stacked arrangement, in which the carrier vehicle comprises a booster rocket body and the second coupling system is configured for selectively coupling and decoupling the composite vehicle directly with respect to a side portion of the booster rocket body.

According to a third aspect of the presently disclosed subject matter there is provided a method for delivering a payload vehicle to a predetermined altitude, comprising:
carrying the payload vehicle from a ground location to a first altitude, while the payload vehicle is concurrently coupled to a booster vehicle to provide a composite vehicle, via a carrier vehicle; and decoupling the composite vehicle from the carrier vehicle at said first altitude and at a first predetermined forward speed; operating the uncoupled booster vehicle of the composite vehicle to transport the booster vehicle to at least a second altitude under propulsive power provided by a ramjet propulsion system comprised in the booster vehicle; and decoupling the payload vehicle from the booster vehicle at said second altitude and at a second predetermined forward speed;
operating the payload vehicle to transport the payload vehicle to at least said predetermined altitude and at a third predetermined forward speed under propulsive power provided by a rocket propulsion system comprised in the payload vehicle.

For example, the payload vehicle, booster vehicle and composite vehicle are as defined herein according to the first aspect of the presently disclosed subject matter.

Additionally or alternatively, for example, the carrier vehicle comprised in the launch system as defined herein according to the second aspect of the presently disclosed subject matter.

Additionally or alternatively, for example, said first altitude is the range between 10,000 m and 20,000 m.

Additionally or alternatively, for example, said second altitude is the range between 30,000 m and 40,000 m.

Additionally or alternatively, for example, said desired altitude is greater than 40,000 m.

A feature of at least one example of the presently disclosed subject matter is that the respective launch system enables the propulsion system of each component vehicle thereof—in particular each one of the booster vehicle, the payload vehicle and the carrier vehicle—to provide optimal performance as a single cycle-single platform component: the carrier vehicle in some examples has turbojet/turbofan propulsion system and propels the launch system from ground level and zero forward speed to the first altitude and a subsonic forward speed exceeding Mach 0.5 at optimal conditions for such an air breathing propulsion system; the booster vehicle has ramjet propulsion system and propels the composite vehicle from the first altitude and subsonic forward speed to the second altitude and supersonic/hypersonic forward speed at optimal conditions for such air breathing propulsion system; the payload vehicle has rocket propulsion system and propels the payload from the second altitude and supersonic/hypersonic forward speed to the desired altitude and desired forward speed at optimal conditions for such a non-air breathing propulsion system.

Another feature of at least one example of the presently disclosed subject matter is that the respective launch system enables the propulsion system of each component vehicle thereof—in particular each one of the booster vehicle, the payload vehicle and the carrier vehicle—to provide optimal performance as a single cycle-single platform component: the carrier vehicle in some examples has turbojet/turbofan propulsion system and propels the launch system from ground level and zero forward speed to the first altitude and a supersonic forward speed exceeding Mach 1.0 at optimal conditions for such an air breathing propulsion system; the booster vehicle has ramjet propulsion system and propels the composite vehicle from the first altitude and low supersonic forward speed to the second altitude and supersonic/hypersonic forward speed at optimal conditions for such an air breathing propulsion system; the payload vehicle has rocket propulsion system and propels the payload from the second altitude and supersonic/hypersonic forward speed to the desired altitude and desired forward speed at optimal conditions for such a non-air breathing propulsion system.

Another feature of at least one example of the presently disclosed subject matter is that the respective launch system enables the propulsion system of some of the component vehicle thereof—in particular each one of the booster vehicle, and the payload vehicle—to provide optimal performance as a single cycle-single platform component, while the carrier vehicle can be configured as a low cost rocket booster. For example, the carrier vehicle in some examples has rocket propulsion system and propels the launch system from ground level and zero forward speed to the first altitude and a supersonic forward speed exceeding Mach 1.0, for example up to Mach 1.5; the booster vehicle has ramjet propulsion system and propels the composite vehicle from the first altitude and low supersonic forward speed to the second altitude and higher supersonic/hypersonic forward speed at optimal conditions for such an air breathing propulsion system; the payload vehicle has rocket propulsion system and propels the payload from the second altitude and supersonic/hypersonic forward speed to the desired altitude and desired forward speed at optimal conditions for such a non-air breathing propulsion system.

Another feature of at least one example of the presently disclosed subject matter is that the respective launch system enables a payload to be launched into the desired altitude with relatively low launch costs as compared with currently available pure rocket launch systems.

Another feature of at least one example of the presently disclosed subject matter is that the respective launch system can provide a larger payload weight for a given all-up weight of the composite vehicle Another feature of at least one example of the presently disclosed subject matter is that the respective launch system, in which the composite air vehicle is air-launched from a carrier vehicle in the form of a subsonic or supersonic carrier aircraft, the payload can have a larger payload weight per se within the weight limitation of the carrier aircraft, as compared with payload weight of other conventional air-launched systems for the same carrier aircraft.

### BRIEF DESCRIPTION OF THE DRAWINGS

In order to better understand the subject matter that is disclosed herein and to exemplify how it can be carried out in practice, examples will now be described, by way of non-limiting example only, with reference to the accompanying drawings, in which:

FIG. 1 is a schematic side view of the launch system according to a first example of the presently disclosed subject matter, including a first example of the second coupling system thereof.

FIG. 2 is a schematic illustration of a launch profile of the launch system according to example of FIG. 1.

FIG. 3(a) is a partial cross-sectional side view of a first example of the composite vehicle of the launch system according to example of FIG. 1; FIG. 3(b) is a partial cross-sectional top view of the example of the composite vehicle of FIG. 3(a).

FIG. 4(a) is a side view of an alternative variation of the example of the composite vehicle of FIG. 3(a); FIG. 4(b) is top view of the example of the composite vehicle of FIG. 4(a).

FIG. 5(a) is a side view of another alternative variation of the example of the composite vehicle of FIG. 3(a); FIG. 5(b) is top view of the example of the composite vehicle of FIG. 5(a); FIG. 5(c) is schematic isometric view of the example of the composite vehicle of FIG. 5(a) illustrating decoupling between the respective booster vehicle and the respective payload vehicle of the composite vehicle.

FIG. 6(a) is a side view of another alternative variation of the example of the composite vehicle of FIG. 3(a); FIG. 6(b) is top view of the example of the composite vehicle of FIG. 6(a); FIG. 6(c) is schematic isometric view of the example of the composite vehicle of FIG. 6(a) illustrating decoupling between the respective booster vehicle and the respective payload vehicle of the composite vehicle.

FIG. 7(a) is a side view of another alternative variation of the example of the composite vehicle of FIG. 3(a); FIG. 7(b) is schematic isometric view of the example of the composite vehicle of FIG. 7(a) illustrating decoupling between the respective booster vehicle and the respective payload vehicle of the composite vehicle.

FIG. 8 is a front view of an alternative variation of the example of the launch system of FIG. 1, including a second example of the second coupling system thereof.

FIG. 9 is a front view of another alternative variation of the example of the launch system of FIG. 1, including a third example of the second coupling system thereof.

FIG. 10 is a front view of another alternative variation of the example of the launch system of FIG. 1, including a fourth example of the second coupling system thereof.

FIG. 11 is a schematic top view of the launch system according to a second example of the presently disclosed subject matter, including the composite vehicle according to the example of FIGS. 4(a) and 4(b).

FIG. 12 schematically illustrates a method for delivering a payload vehicle to a predetermined altitude according to a first example of the presently disclosed subject matter.

### DETAILED DESCRIPTION

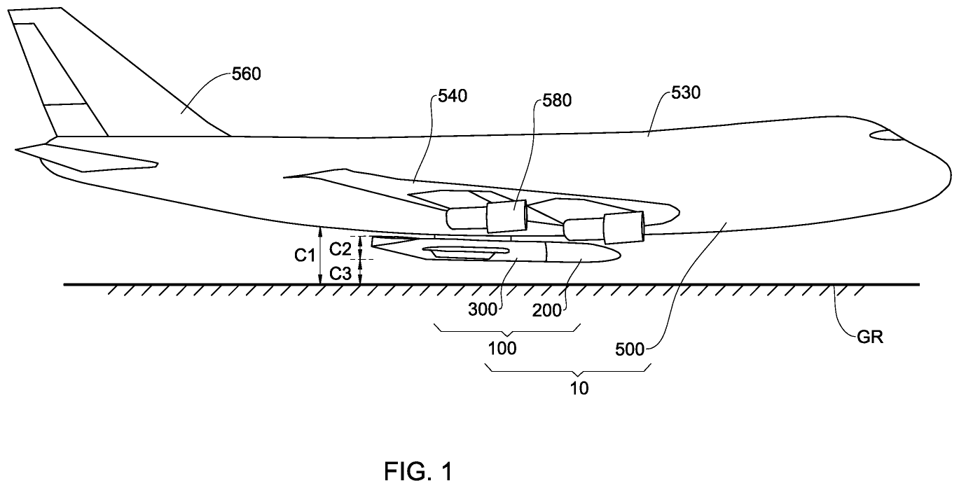

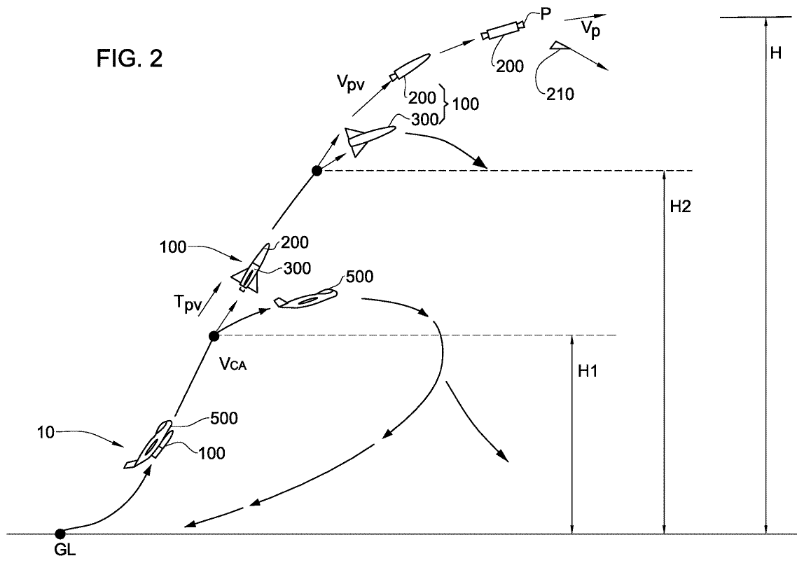

Referring to FIGS. 1 and 2, a launch system for delivering a payload to a predetermined altitude H according to a first example of the presently disclosed subject matter, generally designated 10, comprises a composite vehicle 100 accommodating a payload P, and a carrier vehicle 500.

In at least this example, the predetermined altitude H is typically not less than the range 30 km to 40 km, and can include altitudes up to the Karman line (about 100 km) or more, for example near Earth orbital altitudes (100 km to 700 km), or even greater, for example sun synchronous orbits, geosynchronous orbits, or indeed outer space in which the payload vehicle 200, or the payload P, can accelerate to escape velocity.

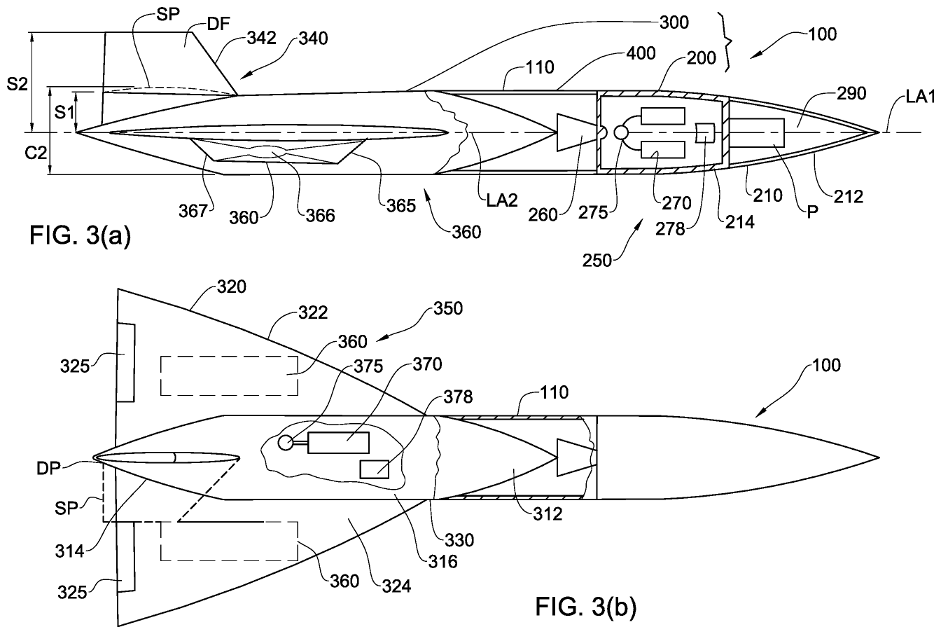

Referring also to FIGS. 3(a) and 3(b), the composite vehicle 100 according to at least a first example thereof, comprises a payload vehicle 200, a booster vehicle 300, and a first coupling system 400.

The payload vehicle 200 is configured for powered spaceflight at least in space medium, and comprises a rocket driven propulsion system 250.

While in this example the payload vehicle 200 is configured as a single stage vehicle, in alternative variations of this example, and in other examples, the payload vehicle 200 is instead configured as a multi-stage vehicle, for example having two or more stacked stages, in which typically the payload P is accommodated in the final stage.

By “space medium” is meant a vacuum or near vacuum, or at least atmospheric conditions consistent with an altitude at which the atmosphere is too thin to support aerodynamic flight (typically about 84 km or higher) and/or too thin to enable propulsive power to be generated by air-breathing engines, including ramjets, scramjets, dual mode ramjet/scramjet (DMRJ) and the like—for example about 36 km to 40 km for ramjets or about 75 km for scramjets.

In at least this example, the rocket driven propulsion system 250 is configured as a single cycle propulsion system, in which at no time, during operation thereof to generate thrust, the rocket driven propulsion system 250 requires any external atmospheric air to be supplied thereto to generate thrust. Rather, all the materials, including as appropriate fuel, oxidizer and so on, are carried by the payload vehicle 200 itself.

In at least this example, the payload vehicle 200 has no other propulsion system other than the rocket driven propulsion system 250, and thus the payload vehicle 200 has an absence of air-breathing engine for the purpose of generating thrust. For example, the payload vehicle 200 has an absence of any one of: a ramjet based propulsion system; a scramjet propulsion system; a turbojet based propulsion system; a turbofan based propulsion system.

Rather, in at least this example, the rocket driven propulsion system 250 comprises at least one rocket engine 260, and suitable propellants. In at least this example, the rocket engine is a chemical rocket engine.

In at least this example, the at least one rocket engine 260 is a liquid fuel rocket engine, and the payload vehicle also comprises suitable propellant tanks 270, including for example fuel tanks and oxidizer tanks, as well as a suitable pump system 275 for supplying propellants to the rocket engine 260 from the propellant tanks 270, and control system 278 for controlling operation of the pimp system 275 and/or rocket engine 260 in particular the thrust generated thereby.

In alternative variations of this example, the rocket driven propulsion system 250 comprises at least one chemical rocket engine 260 in the form of a solid rocket engine, having solid propellants.

In any case, the configuration of the rocket driven propulsion system 250, for example the number of rocket engines 260 and/or the respective specific impulse (I_{SP}) thereof (for example in the range of 250/sec to 420/sec), can depend on the particulars of the mission for which it is intended to operate the payload vehicle 200. Such particular can include, for example the weight of the payload P to be carried by the payload vehicle 200, the magnitude of the respective predetermined altitude H, the velocity V_{P} to be provided to the payload P (for example: sub orbital velocity, or, orbital velocity at a particular orbital altitude, or, escape velocity), and other mission parameters, for example whether or not the payload P (or part thereof) is to be returned to Earth.

In at least this example, the payload vehicle 200 comprises a body 210 that is aerodynamically contoured for minimizing aerodynamic drag. In at least this example, the body 210 has a forward ogive-shaped nose portion 212, and a generally cylindrical or frusto-conical aft body section 214. In at least this example, the rocket driven propulsion system 250 is provided in the aft body section 214.

While in this example the body 210 has circular transverse cross-sections, in alternative variations of this example and in other examples, the body transverse cross sections can have any other suitable shape, for example, oval, elliptical, super-elliptical, polygonal, and so on. In yet in other alternative variations of this example and in other examples, the body 210 can be configured as a lifting-body, in which the body 210 itself can generate aerodynamic lift at lower altitudes.

While in this example the payload vehicle 200 is devoid of any aerodynamic lift-producing wings, in alternative variations of this example and in other examples, the payload vehicle 200 can have aerodynamic lift-producing wings, affixed to the body 210.

In at least this example, the payload vehicle 200 can be configured for spin stabilization when operating on its own, and disengaged from the booster vehicle. In such spin stabilization, the payload vehicle 200 spins in roll about a longitudinal axis LA1 of the payload vehicle 200.

In at least this example, the payload vehicle 200 the payload vehicle comprises a payload vehicle payload bay 290, configured for accommodating therein a payload P. In at least this example, the payload vehicle payload bay 290 is located within the body 210. Furthermore, the payload vehicle can be configured for exposing the payload P (while still engaged to the payload vehicle 200) with respect to the external environment, and/or for releasing the payload P from the payload vehicle payload bay 290, at predetermined conditions.

For example, the payload vehicle 200 can be configured with an ejectable nose portion 212, and the nose portion 212 can be selectively ejected to expose the payload vehicle payload bay 290, and optionally to selectively disengage the payload P therefrom and thereby allow separation of the payload P from the payload vehicle 200.

Alternatively, the payload vehicle 200 can be configured with openable or ejectable payload bay doors, which can be selectively opened or ejected, respectively, to expose the payload vehicle payload bay 290, and optionally to selectively disengage the payload P therefrom and thereby allow separation of the payload P from the payload vehicle 200.

In at least some examples, the payload vehicle 200 is configured for being maneuvered (automatically, autonomously, or under human control via remote control) during and up to attaining the desired height H. Additionally or alternatively, at least some examples, the payload vehicle 200 is configured for re-entry or otherwise recovered via ground landing or sea landing, for example using a parachute system that can be deployed from the payload vehicle 200 at predetermined conditions.

In at least this example, the booster vehicle 300 is configured for powered aerodynamic flight at least between a first altitude H1 and a second altitude H2. The booster vehicle 300 is configured for powered aerodynamic flight, up to second altitude H2, which can, in at least some examples, include, as a maximum limit, altitudes up until the atmosphere is too thin to support aerodynamic flight (i.e., typically at altitudes of about 84 km or less) and/or too thin to enable propulsive power to be generated by air-breathing engines, including at least ramjets, scramjets and the like. In at least this example, the first altitude H1, which is lower than the second altitude H2, can include as a maximum limit the maximum altitude at which the carrier vehicle 500 can operate in powered aerodynamic flight while concurrently carrying the composite vehicle 100. For example, the first altitude H1 can be in the range of 8,000 m to 12,000 m, or in the range 10,000 m to 20,000 m. For example, the second altitude H2 can be in the range of 30,000 m to 40,000 m

In particular, the booster vehicle 300 is configured for powered supersonic/hypersonic aerodynamic flight, i.e., for powered supersonic flight and/or for powered hypersonic flight, between the first altitude H1 and the second altitude H2. The booster vehicle 300 thus comprises a ramjet propulsion system 350, configured for transporting the composite vehicle 100 between the first altitude H1 and the second altitude H2 under propulsive power provided by said ramjet propulsion system 350.

In at least this example, the ramjet propulsion system 350 is configured as a single cycle propulsion system.

By “ramjet propulsion system” is meant an air-breathing propulsion system in which at no time, during operation thereof to generate thrust, the ramjet propulsion system requires any external atmospheric air to be compressed by means of a compressor, for example a mechanical rotary-based compressor (i.e., having a rotary component that is turned to thereby compress air passing through the rotary component), for example an axial compressor or a centrifugal compressor (for example of a turbojet engine or turbofan engine) to generate thrust. Rather, all the air compression required by the ramjet propulsion system 350 is provided as a result of the forward speed of the booster vehicle 300 itself, and the geometry of the intake of the ramjet engine.

In at least this example, the booster vehicle 300 has no other propulsion system other than the ramjet propulsion system 350, and is thus an exclusively ramjet propulsion system. Thus the booster vehicle 300 has an absence of any air-breathing engine that includes a compressor (for example a mechanical rotary-based compressor, for example an axial compressor or a centrifugal compressor) for the purpose of generating thrust (for example the booster vehicle 300 has an absence of a turbojet based propulsion system and/or an absence of a turbofan based propulsion system), and/or an absence of any type of non-air-breathing engine that does not require the continuous provision of atmospheric air for the purpose of generating thrust (for example the booster vehicle 300 has an absence of rocket engines).

For example, the ramjet propulsion system 350 comprises at least one of: a pure ramjet engine; a solid fuel integrated rocket ramjet engine (SFIRR); a scramjet engine, a DMRJ.

In at least this example, the ramjet propulsion system 350 comprises at least one ramjet engine 360, and the ramjet propulsion system 350 also comprises (carried by the booster vehicle 300) suitable propellant tanks 370, including for example fuel tanks, as well as a suitable pump system 375 for supplying propellants to the ramjet engine 360 from the propellant tanks 370, and control system 378 for controlling operation of the pump system 375 and/or ramjet engine 360 in particular the thrust generated thereby. The ramjet engine 360 includes a suitable intake 365, combustion chamber 366 and exhaust nozzle 367.

In any case, the configuration of ramjet propulsion system 350, for example the number of ramjet engines 360 and/or the respective specific impulse (I_{SP}) thereof (for example in the range 1200/sec to 2200/sec), can depend on the particulars of the mission for which it is intended to operate the booster vehicle 300. Such particular can include, for example the weight of the payload vehicle 200 to be carried by the booster vehicle 300 in the composite vehicle 100 configuration, the magnitude of the respective second altitude H2, the velocity V_{PV} to be provided to the payload vehicle 200 such as to enable the payload vehicle to be operated, after separation from the booster vehicle 300, such as to provide the payload P with the desired velocity V_{P} (for example: sub orbital velocity, or, orbital velocity at a particular orbital altitude, or, escape velocity), and other mission parameters.

In at least this example, the ramjet propulsion system 350 is configured for providing a baseline thrust T_{BV} at a predetermined forward velocity V_{CA} that can be provided by the carrier vehicle 500. For example, such a predetermined forward velocity V_{CA} can be Mach 0.5 or higher, for example about Mach 0.85 (when the carrier vehicle 500 is a subsonic turbofan aircraft), or for example Mach 1.5 (when the carrier vehicle 500 is a supersonic aircraft or a rocket booster vehicle). Furthermore, the ramjet propulsion system 350 is configured for providing sufficient thrust for accelerating the payload vehicle 200 (when coupled thereto in the composite vehicle 100) to Mach number in the region of 3 and 6, or beyond, for example Mach 5.

In alternative variations of this example, the ramjet propulsion system 350 comprises at least one scramjet engine and/or solid fuel integrated rocket ramjet engine (SFIRR) and/or DMRJ.

In at least this example, the booster vehicle 300 comprises a fuselage 330 that is aerodynamically contoured for minimizing aerodynamic drag. In at least this example, the fuselage 330 has a forward ogive-shaped nose 312, and a generally cylindrical or frusto-conical mid fuselage section 316, and a tapering aft fuselage section 314.

While in this example the fuselage 330 has circular transverse cross-sections along the longitudinal axis LA2 thereof, in alternative variations of this example and in other examples, the fuselage transverse cross sections can have any other suitable shape, for example, oval, elliptical, super-elliptical, polygonal, and so on. In yet in other alternative variations of this example and in other examples, the fuselage 330 can be configured as a lifting-body, in which the fuselage 330 itself can generate aerodynamic lift at lower altitudes at or below the second altitude H2.

In at least this example, the booster vehicle 300 comprises an aerodynamic wing system 320, configured for providing lift, stability and control to at least the composite vehicle 100, via the booster vehicle 300, at least at supersonic/transonic conditions between the first altitude H1 and the second altitude H2. In at least this example, the aerodynamic wing system 320 is also configured for providing lift, stability and control to the booster vehicle 300, when disengaged from the payload vehicle 200, within the flight envelope of the booster vehicle 300 when operated by itself.

Furthermore, in at least this example, the aerodynamic wing system 320 is configured for providing lift, stability and control to the composite vehicle 100, as well as the booster vehicle 300 when separated from the payload vehicle, also at subsonic and transonic conditions, either when accelerating to supersonic conditions, or decelerating from supersonic conditions.

In at least this example, the booster vehicle 300 comprises a fuselage 330, and the aerodynamic wing system 320 comprises a delta wing, having a port wing 322 and a starboard wing 324 affixed to the fuselage 330. The port wing 322 and starboard wing 324 each comprise control surfaces in the form of elevons 325, for pitch control as well as roll control.

In at least this example, the ramjet propulsion system 350 is affixed to the aerodynamic wing system 320. In at least this example, the ramjet propulsion system 350 comprises two ramjet engines 360, one ramjet engine 360 mounted to each of the port wing 322 and the starboard wing 324. In alternative variations of this example, the ramjet propulsion system 350 can comprise more than two ramjet engines 360, while in other alternative variations of this example, the ramjet propulsion system 350 can comprise one ramjet engine 360, for example mounted to the fuselage 330.

The booster vehicle 300, particular the aerodynamic wing system 320, further comprises a vertical stabilizer arrangement 340 for yaw control. In at least this example, the vertical stabilizer arrangement includes one fin 342 pivotable between a stowed position SP and a deployed position DP. In alternative variations of this example, the vertical stabilizer arrangement includes more than one fin pivotable between a respective stowed position and a respective deployed position. In any case, in the stowed position SP the fin 342 has a first height dimension S1, and in the deployed position DP the fin 342 has a second height dimension S2, the second height dimension S2 being greater than the first height dimension S1. In the deployed position DP the fin 342 is configured for generating stability and control moments to the composite vehicle 100, as well as to the booster vehicle 300 when separated from the payload vehicle 200.

While in at least this example, the pivotable fin 342 is pivotably mounted to the fuselage 330 on a top part thereof, in alternative variations of this example the pivotable fin 342 can pivotably mounted to a bottom part of the fuselage 330, or to the aerodynamic wing system, for example at least one fin mounted to the port wing 322 and at least one fin mounted to the starboard wing 324, for example at the wing tips thereof.

In alternative variations of the above example, the aerodynamic wing system 320 comprises a vertical stabilizer arrangement including at least one fin fixedly mounted to the booster vehicle 300, for example to the fuselage 330, and/or to the wings 342, 344.

In yet other alternative variations of the above examples, the booster vehicle 300 does not have a fuselage, and is provided as a flying wing—comprised mostly of the aerodynamic wing system 320.

In yet other alternative variations of the above examples, the booster vehicle 300 is configured as a blended wing body vehicle, integrating the fuselage 330 and the aerodynamic wing system 320.

In these or other alternative variations of the above examples, the aerodynamic wing system 320 further comprises canards, which can be affixed to the nose 312; alternatively, the canards can be affixed to the payload vehicle 200, and are only needed while the booster vehicle 300 and the payload vehicle 200 are coupled together to form the composite vehicle 100.

In yet other alternative variations of the above examples, the aerodynamic wing system is in the form of variable geometry wings (so-called “swing wing”), or double delta wings, or swept wings.

The first coupling system 400 is for selectively coupling and decoupling the payload vehicle 200 with respect to the booster vehicle 300. When the first coupling system 400 is in coupled configuration, the payload vehicle 200 is coupled to the booster vehicle 300 and the two vehicles operate together as a single vehicle—the composite vehicle 100. In the decoupled configuration, the payload vehicle 200 is decoupled with respect to the booster vehicle 300, and each one of payload vehicle 200 and the booster vehicle 300 operate independently of one another.

In at least this example, the first coupling system 400 is configured for coupling the payload vehicle 200 with the booster vehicle 300 in longitudinal stacked arrangement, in which at least a forward part of the payload vehicle 200 is longitudinally forward with respect to the booster vehicle 300, along the first longitudinal axis LA1 and the second longitudinal axis LA2. For example, the first coupling system 400 comprises a plurality of explosive bolts that, in the coupled configuration, mechanically hold together the payload vehicle 200 with the booster vehicle 300 in load bearing relationship, and when actuated in the uncoupled configuration enable the payload vehicle 200 to separate from the booster vehicle 300.

The booster vehicle 300 is further configured for being flown independently of the payload vehicle 200, and thus can be maneuvered (automatically, autonomously, or under human control via remote control) to be flown to a recovery site, and recovered there by controlled horizontal landing, in which case the booster vehicle 300 comprises a suitable undercarriage. For example such undercarriage can be conventional deployable/retractable undercarriage, or alternatively, can be “down only” landing gear that only deploys (and has no hydraulic mechanism for retraction of the landing gear—this can only be done by work crews on the ground) thereby saving weight and complexity. Alternatively, the booster vehicle 300 can be recovered via parachute that can be deployed from the booster vehicle 300 at predetermined conditions.

As best seen in FIGS. 3(a) and 3(b), in at least this example the composite vehicle 100 further comprises a payload module adaptor 110 in the form of a fairing that interconnects the payload vehicle 200 with the booster vehicle 300 while in coupled mode. The payload module adaptor 110 provides aerodynamic continuity between the payload vehicle 200 and the booster vehicle 300, and can be discarded when the payload vehicle 200 becomes uncoupled with the booster vehicle 300 in uncoupled mode. The first coupling system 400 can be provided between the payload module adaptor 110 and the payload vehicle 200, and/or between the payload module adaptor 110 and the booster vehicle 300.

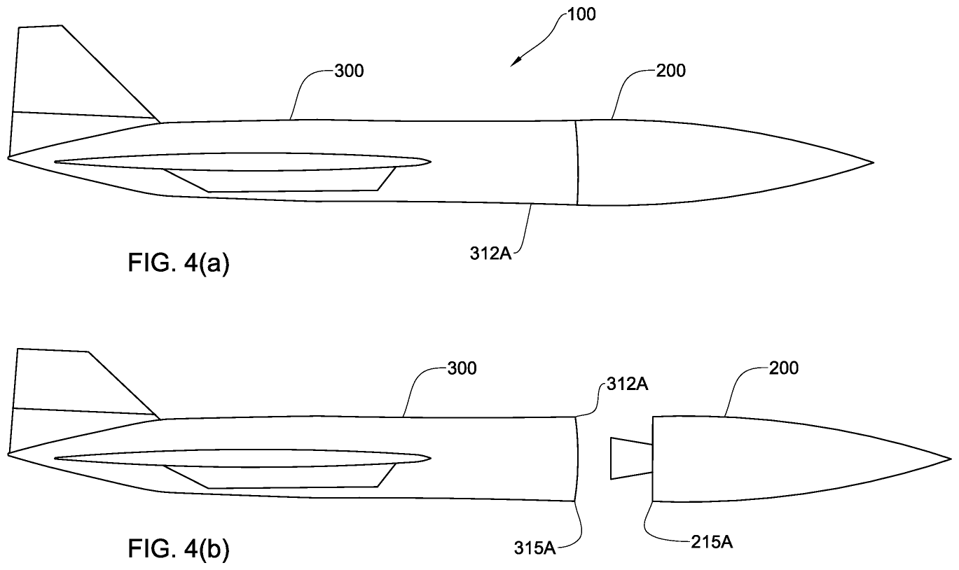

Referring to FIGS. 4(a) and 4(b), an alternative variation of the example of FIGS. 3(a) and 3(b) is illustrated, in which the booster vehicle 300 has a modified nose 312A that is directly coupled to the aft end of the payload vehicle 200 in the coupled mode. The modified nose 312A is blunt and comprises a forward periphery 315A that couples directly to an aft periphery 215A of the aft body section 214 via explosive bolts or the like, for example.

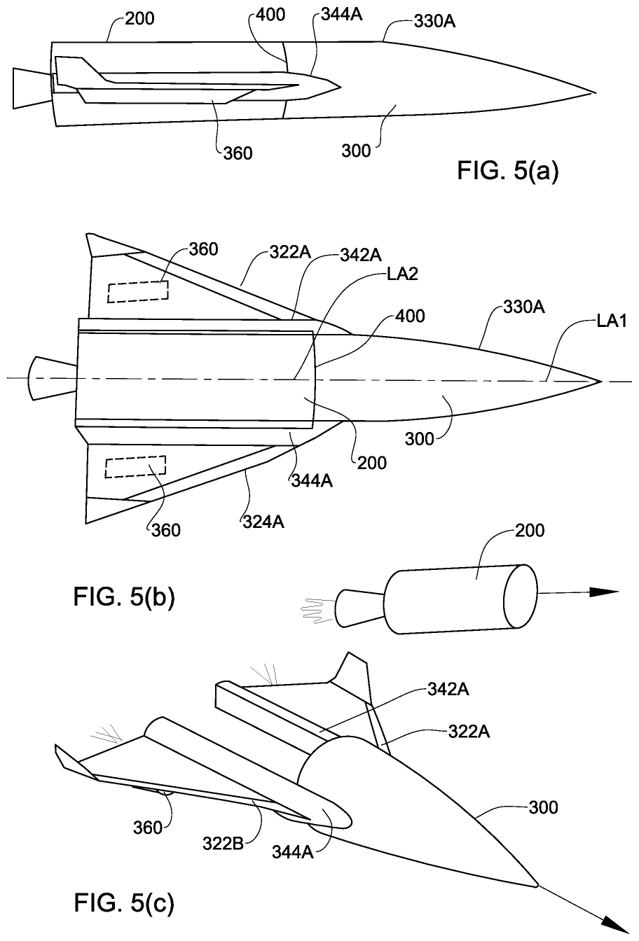

Referring to FIGS. 5(a), 5(b) and 5(c), an alternative variation of the example of FIGS. 3(a), 3(b), 4(a), 4(b) is illustrated, in which the respective first coupling system 400 is configured for coupling the payload vehicle 200 with the booster vehicle 300 in longitudinal stacked arrangement, in which at least a forward part of the booster vehicle 300 is longitudinally forward with respect to the payload vehicle 200, along the first longitudinal axis LA1 and the second longitudinal axis LA2. In this example, the port wing 322A and starboard wing 324A of the corresponding aerodynamic wing system are mounted on booms 342, 344, respectively, that project aft from the aft end of respective fuselage 330A. The booms 342, 344 are co-extensive with the payload vehicle 200, and are thus located on either side of the payload vehicle 200 when the payload vehicle 200 is coupled with the booster vehicle 300. In this example, the aerodynamic wing system 320 comprises a vertical stabilizer arrangement including at least one fin fixedly mounted to the booster vehicle 300, for example to the wing tips of wings 342A, 344A. As illustrated in FIG. 5(c), in decoupled configuration, first coupling system 400 decouples the payload vehicle 200 with respect to the booster vehicle 300, and each one of the payload vehicle 200 and the booster vehicle 300 follows its respective trajectory.

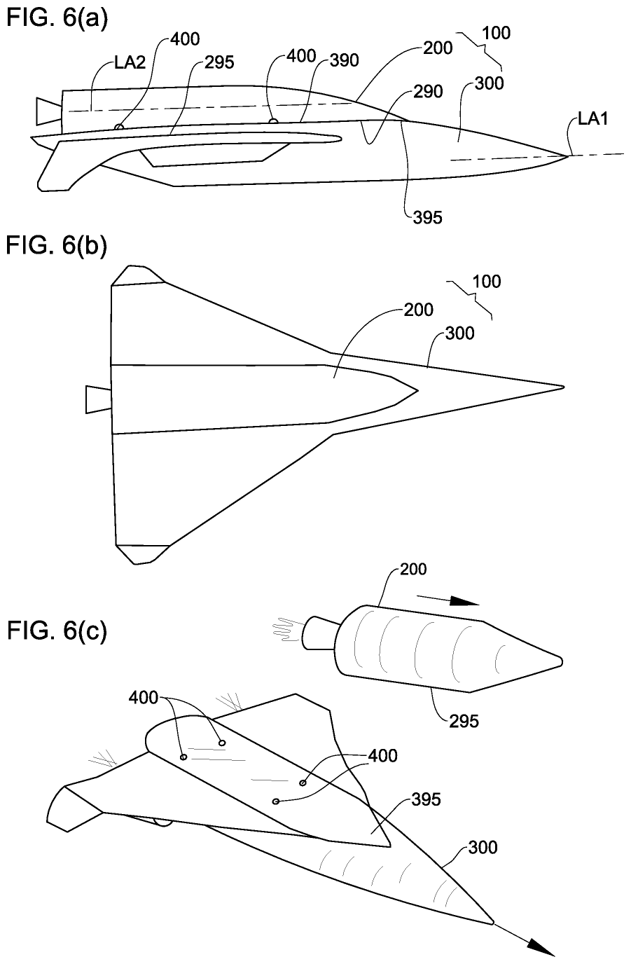

Referring to FIGS. 6(a), 6(b) and 6(c), an alternative variation of the examples of FIGS. 3(a) to 5(c) is illustrated, in which the respective first coupling system 400 is configured for coupling the payload vehicle 200 with the booster vehicle 300 in transverse stacked arrangement, in which at least a first part 290 of the payload vehicle 200 is in transverse overlying relationship with respect to which at least a first part 390 the booster vehicle 300, along a direction not parallel to the first longitudinal axis LA1 and the second longitudinal axis LA2. In this example, the first part 390 of the booster vehicle 300 is provided by an upper fuselage portion 395 of fuselage 330B of the booster vehicle 300. In this example the upper fuselage portion 395 can be relatively flat. In this example, the first part 290 of the payload vehicle 200 is provided by a lower body portion 295 of body 210B of the payload vehicle 200. In this example the lower body portion 295 is relatively flat, and essentially abuts or at least overlies the upper fuselage portion 395 in coupled configuration. As illustrated in FIG. 6(c), in decoupled configuration, the respective first coupling system 400 decouples the payload vehicle 200 with respect to the booster vehicle 300, and each one of the payload vehicle 200 and the booster vehicle 300 follows its respective trajectory.

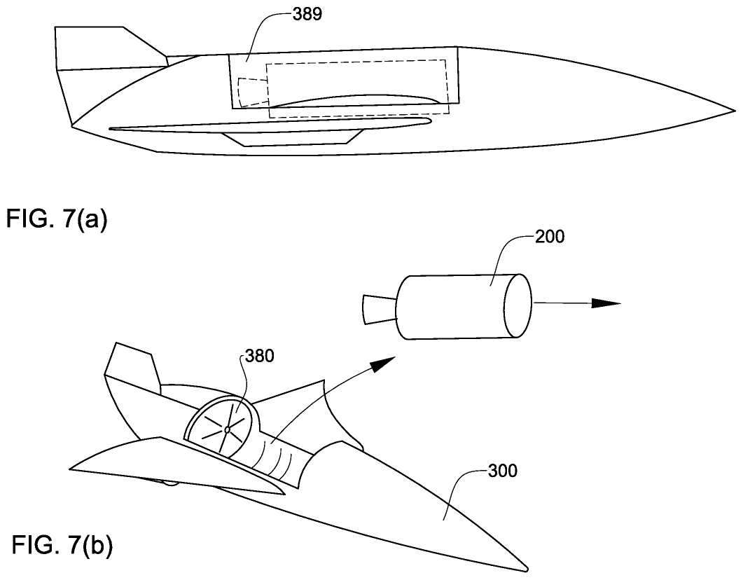

Referring to FIGS. 7(a) and 7(b), an alternative variation of the examples of FIGS. 3(a) to 6(c) is illustrated, in which the booster vehicle 300 comprises a booster vehicle payload bay 380, which has an internal geometry and dimensions sufficient for enabling the payload vehicle 200 to be accommodated in the booster vehicle payload bay 380. The booster vehicle payload bay 380 is further configured for allowing egress of the payload vehicle 200 therefrom, and for this purpose the respective fuselage 330 comprises payload doors 389 which can selectively open to expose the booster vehicle payload bay 380 to the external environment. The respective first coupling system 400 is configured for selectively coupling and decoupling the payload vehicle 200 with respect to the booster vehicle payload bay 380 of the booster vehicle 300. As illustrated in FIG. 7(c), in decoupled configuration, the respective first coupling system 400 decouples the payload vehicle 200 with respect to the booster vehicle 300, and the payload vehicle 200 egresses from the booster vehicle payload bay 380; thereafter each one of the payload vehicle 200 and the booster vehicle 300 follows its respective trajectory.

In the above examples the booster vehicle 300 and the payload vehicle 200 are each unmanned, and thus each comprises a respective control system including one or more of a communications module, a navigation module, and a control module, for controlling the various functions of the booster vehicle 300 and the payload vehicle 200, respectively. Such control systems enable the composite vehicle 100 to be flown to the desired second altitude H2 after separation from the carrier vehicle 500, enable the booster vehicle 300 and the payload vehicle 200 to become decoupled from one another, and further allows the payload vehicle 200 to continue under power to the desired height H to thereby deploy or operate the payload P, while enabling the booster vehicle 300 to be flown back to a desired location and landed there. In alternative variations of this example, and in other examples, the booster vehicle 300 and/or the payload vehicle 200 can be configured as manned vehicles.

Referring again to FIG. 1, in at least this example the carrier vehicle 500 is configured at least for powered subsonic aerodynamic flight, and further configured for transporting the composite vehicle 100 to at least the first altitude H1 from a ground location GL. For example, the carrier vehicle 500 has a fuselage 530, main lift generating wings 540 and empennage 560, and a propulsion system 580 that is configured to enable the carrier vehicle 500, while carrying the composite vehicle 100, to reach at least the first altitude H1, as well as the aforesaid predetermined forward velocity V_{CA}, which can be Mach 0.5 or higher for example. Thus the payload weight capacity of the carrier vehicle 500 is at least equal to the all-up weight of the composite vehicle 100.

For example, such a carrier vehicle 500 can be a Boeing 747 aircraft; alternatively, such a carrier vehicle 500 can be any one of a Boeing 767 aircraft, Airbus 320 aircraft, Airbus 380 aircraft, White Knight 2 aircraft, Stratolaunch, and so on.

In this example and in other examples, the system 10 further comprises a second coupling system 700 for selectively coupling and decoupling the composite vehicle 100 with respect to the carrier vehicle 500.

In the first example of the second coupling system 700 illustrated in FIG. 1, the second coupling system 700 is configured for coupling the composite vehicle 100 with the carrier vehicle 500 in transverse stacked arrangement, in which the carrier vehicle 500 is in at least partial transverse (vertical) overlying relationship with respect to the composite vehicle 100. In other words, the composite vehicle 100 is vertically below the underside of the carrier aircraft when coupled thereto via the second coupling system 700.

In this example, the second coupling system 700 is configured for coupling the composite vehicle 100 with the carrier vehicle 500 in the aforesaid transverse stacked arrangement, wherein the carrier vehicle 500 fuselage is already configured to, or alternatively is modified structurally to, incorporate the second coupling system 700. In particular the second coupling system 700 is configured for selectively coupling and decoupling the composite vehicle 100 directly with respect to a lower portion 535 of the carrier aircraft fuselage 530. The second coupling system 700 can therefore be mounted with respect to hard points on the lower portion 535 of the carrier aircraft fuselage 530.

For example, the second coupling system 700 can comprise one or more hooks provided in the lower portion 535 of the carrier aircraft fuselage 530, and configured to engage with lugs provided in the upper portion of the composite vehicle 100, either on one or both of the booster vehicle 300 and the payload vehicle 200. For example, on actuation, the hooks can be selectively moved from an engaged position, in load bearing contact with the lugs, to a disengaged position, in which the hooks are disengaged from the lugs, allowing the composite air vehicle 100 to separate from the carrier vehicle 500.

In at least this example, and referring again to FIG. 1, the carrier vehicle 500 has a fuselage ground clearance C1, being defined as the vertical spacing between the underside of the carrier aircraft fuselage 530 and the ground GR, when the carrier aircraft has the undercarriage deployed and is resting statically on the ground.

In this example, and referring also to FIG. 3(a), the composite vehicle 100 has a height dimension C2, when coupled to the carrier vehicle 500, less than the fuselage ground clearance C1 of the carrier vehicle 500, leaving a composite vehicle ground clearance C3 between the underside of the composite vehicle 100 and the ground GR.

It is to be noted that composite vehicle ground clearance C3 is not least than the minimum fuselage ground clearance permitted for the particular type of carrier vehicle 500.

It is to be noted that in the first example of the composite vehicle 100, illustrated in FIGS. 3(a) and 3(b), the fin 342 is pivotable between the stowed position SP and the deployed position DP, such that when the composite vehicle 100 is coupled to the carrier vehicle 500 the composite vehicle height dimension C2 is minimized, enabling the composite vehicle 100 to be mounted on the underside of the carrier vehicle 500 while still retaining an allowable composite vehicle ground clearance C3 to enable safe take-off of the launch system 10, and/or to enable safe landing of the launch system 10, for example in emergency cases where it is required to land the carrier vehicle 500 together with the composite vehicle 100

It is to be noted that such an example of the second coupling system 700 can be used for coupling the composite vehicle 100, according to any of the examples illustrated in FIGS. 1 to 7(b), to the carrier vehicle 500, subject to weight limitations as permitted for the carrier aircraft fuselage.

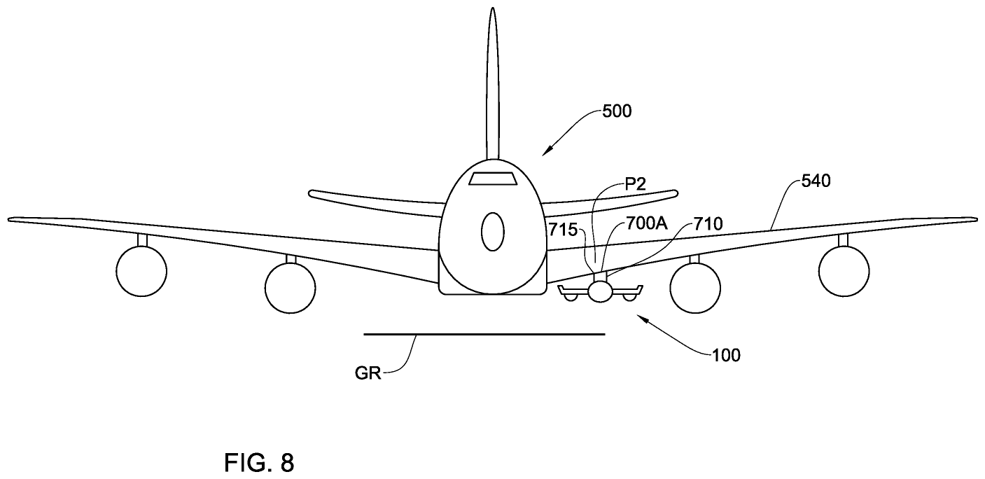

Referring to FIG. 8, in a second example of the second coupling system, the second coupling system, generally designated with reference numeral 700A is similar to the second coupling system 700 of the first example, mutatis mutandis, and is similarly configured for coupling the composite vehicle 100 with the carrier vehicle 500 in transverse stacked arrangement, in which the carrier vehicle 500 is in at least partial transverse (vertical) overlying relationship with respect to the composite vehicle 100. In other words, the composite vehicle 100 is vertically below the underside of the carrier aircraft when coupled thereto via the second coupling system 700A.

However in the second example, the second coupling system 700A is in the form of a wing pylon 710 affixed to a wing 540 of the carrier aircraft, and configured for coupling the composite vehicle 100 with the carrier vehicle 500 via the wing pylon 710. For example, the carrier vehicle 500 can be modified to provide such a load-carrying pylon 710 on the underside of the port wing or of the starboard wing thereof.

Alternatively, and when such a carrier vehicle 500 is a Boeing 747 aircraft, in at least some examples of such a carrier aircraft, the carrier aircraft already has a pylon attachment zone PZ with suitable anchor points 715 provided on the port wing between the fuselage and the inner engine, and such a pylon attachment zone PZ is sometimes used to ferry a fifth, non-operational engine by the carrier aircraft, by mounting the fifth engine to the pylon attachment zone PZ. In such examples, in which the carrier aircraft is a Boeing 747 type aircraft, the wing pylon 710 can be mounted to the port wing 540 thereof, and attached to the aforesaid anchor points on the underside of the port wing, inboard of the operating engines of the carrier vehicle 500.

For example, the wing pylon 710 can comprise one or more hooks configured to engage with lugs provided in the upper portion of the composite vehicle 100, either on one or both of the booster vehicle 300 and the payload vehicle 200. For example, on actuation, the hooks can be selectively moved from an engaged position, in load bearing contact with the lugs, to a disengaged position, in which the hooks are disengaged from the lugs, allowing the composite air vehicle 100 to separate from the carrier vehicle 500.

It is to be noted that the second coupling system 700A, particularly in the form of a wing pylon 710, can be used for coupling the composite vehicle 100, according to any of the examples illustrated in FIGS. 1 to 8, to the carrier vehicle 500, subject to weight limitations as permitted for the aforesaid anchor points. For example, in a standard Boeing 747 fitted with such a wing pylon 710, the maximum all-up weight of the composite vehicle 100 can be, for example, up to 6,500 Kg or for example up to 22,500 Kg.

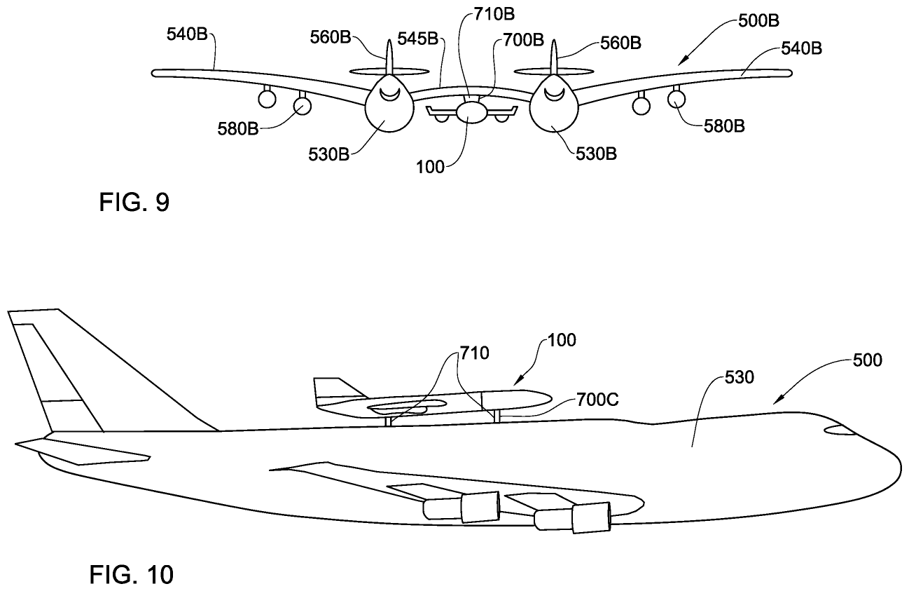

Referring to FIG. 9, in a third example of the second coupling system, the second coupling system, generally designated with reference numeral 700B is similar to the second coupling system 700 of the first example or second example, mutatis mutandis, and is similarly configured for coupling the composite vehicle 100 with the carrier vehicle 500 in transverse stacked arrangement, in which the carrier vehicle 500 is in at least partial transverse (vertical) overlying relationship with respect to the composite vehicle 100. In other words, the composite vehicle 100 is vertically below the underside of part of the carrier aircraft when coupled thereto via the second coupling system 700B.

However in the third example, the carrier vehicle is also in the form of a carrier aircraft, generally designated 500B in FIG. 9, comprises two fuselages 530B, each having an outboard wing 540B, and further comprising an interconnecting wing 545B interconnecting the two fuselages 530B. the carrier vehicle 500B also has an empennage 560B, and a propulsion system 580B that is configured to enable the carrier vehicle 500B, while carrying the composite vehicle 100, to reach at least the first altitude H1, as well as the aforesaid predetermined forward velocity V_{CA}, which can be Mach 0.5 or higher for example. Thus the payload weight capacity of the carrier vehicle 500B is at least equal to the all-up weight of the composite vehicle 100.

In this example, the second coupling system 700B is in the form of a wing pylon 710B affixed to the interconnecting wing 545B of the carrier vehicle 500B, and is configured for coupling the composite vehicle 100 with the carrier vehicle 500B via the wing pylon 710B. For example, such a carrier vehicle 500 can be similar in type to the White Knight Two aircraft, provided by Scaled Composites, USA, or the Stratolaunch aircraft provided by Scaled Composites, USA.

For example, the wing pylon 710B can comprise one or more hooks configured to engage with lugs provided in the upper portion of the composite vehicle 100, either on one or both of the booster vehicle 300 and the payload vehicle 200. For example, on actuation, the hooks can be selectively moved from an engaged position, in load bearing contact with the lugs, to a disengaged position, in which the hooks are disengaged from the lugs, allowing the composite air vehicle 100 to separate from the carrier vehicle 500.

It is to be noted that the second coupling system 700B, particularly in the form of a wing pylon 710B, can be used for coupling the composite vehicle 100, according to any of the examples illustrated in FIGS. 1 to 7(b), to the carrier vehicle 500B, subject to weight limitations as permitted for the aforesaid wing pylon 710B. For example, in a Whiteknight 2 fitted with such a wing pylon 710B, the maximum all-up weight of the composite vehicle 100 can be, for example, up to 17,000 Kg.

Referring to FIG. 10, in a fourth example of the second coupling system, the second coupling system, generally designated with reference numeral 700C is similar to the second coupling system 700 of the first example, second example or third example, mutatis mutandis, and is similarly configured for coupling the composite vehicle 100 with the carrier vehicle 500 in transverse stacked arrangement. However, in this example, in transverse stacked arrangement the composite vehicle 100 is in at least partial transverse (vertical) overlying relationship with respect to the carrier vehicle 500. In other words, the composite vehicle 100 is vertically above the upper part of the carrier aircraft when coupled thereto via the second coupling system 700C.

In the fourth example, the second coupling system 700C is in the form of a plurality of fuselage struts 710C affixed to an upper part of the fuselage 530 of the carrier vehicle 500, and configured for coupling the composite vehicle 100 with the carrier vehicle 500 via the fuselage struts 710C. For example, the carrier vehicle 500 can be modified to provide such fuselage struts 710C on the upper part of the fuselage 530 thereof. For example, such a carrier vehicle 500 is a Boeing 747 aircraft.

In this example, the second coupling system 700C is configured for coupling the composite vehicle 100 with the carrier vehicle 500 in the aforesaid transverse stacked arrangement, wherein the carrier aircraft fuselage is modified structurally to incorporate the second coupling system 700C. In particular the second coupling system 700C is configured for selectively coupling and decoupling the composite vehicle 100 directly with respect to a upper portion of the carrier aircraft fuselage 530. The second coupling system 700C can therefore be mounted to hard points on the upper portion of the carrier aircraft fuselage 530.

For example, the second coupling system 700C can comprise one or more hooks provided in the lower portion of the composite vehicle 100, and configured to engage with lugs provided in the upper portions of the fuselage struts 710C. For example, on actuation, the hooks can be selectively moved from an engaged position, in load bearing contact with the lugs, to a disengaged position, in which the hooks are disengaged from the lugs, allowing the composite air vehicle 100 to separate from the carrier vehicle 500.

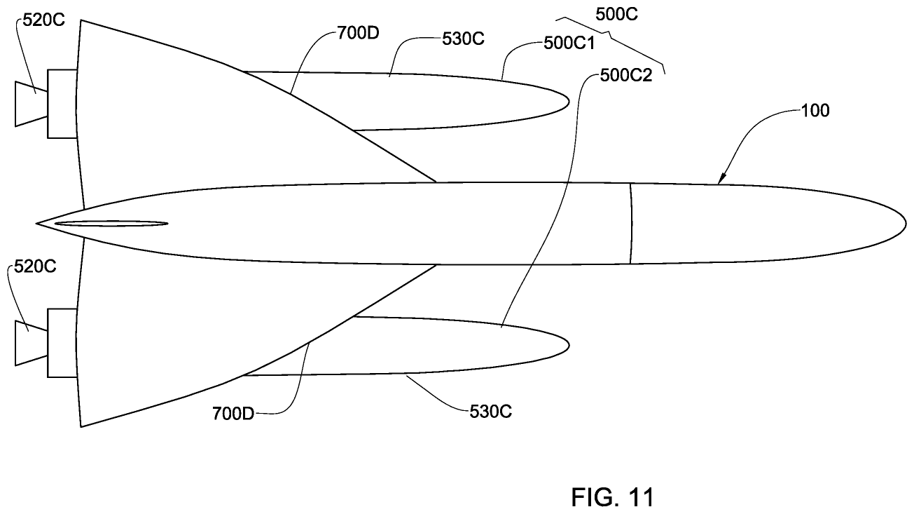

In a second example of the carrier vehicle, and referring to FIG. 11, the carrier vehicle 500 is configured as a rocket booster vehicle, and is designated herein the reference number 500C. in the illustrated example, the rocket booster vehicle 500C comprises a port booster 500C1 and a starboard booster 500C2, each of which comprises booster body 530C, accommodating suitable propellants (for example solid rocket propellants or liquid propellants) and one or more suitable rocket engines 520C. The the rocket booster vehicle 500C, in particular the port booster 500C1 and a starboard booster 500C2, and a fifth example of the second coupling system, the second coupling system, generally designated with reference numeral 700D, which is similar to the second coupling system 700 of the first example, second example, third example or fourth example, mutatis mutandis, and is similarly configured for coupling the composite vehicle 100 with the carrier vehicle 500C in transverse stacked arrangement. However, in this example, in transverse stacked arrangement the composite vehicle 100 is in at least partial transverse (sideways) overlying relationship with respect to the carrier vehicle 500C, in particular with respect to each of the booster bodies 530C, when the rocket booster vehicle 500 is in vertical orientation suitable for vertical take-off. In other words, the composite vehicle 100 is adjacent to the carrier vehicle when coupled thereto via the second coupling system 700D.

In the fifth example, the second coupling system 700D is in the form of a plurality of struts affixed to a side part of the booster body 530 of each one of the port booster 500C1 and starboard booster 500C2, of carrier vehicle 500C, and configured for coupling the composite vehicle 100 with the carrier vehicle 500C via the struts.

In particular the second coupling system 700D is configured for selectively coupling and decoupling the composite vehicle 100 directly with respect to each one of the two booster bodies 530C. For example, the second coupling system 700D can comprise one or more hooks provided in the lower portion of the composite vehicle 100, and configured to engage with lugs provided in the corresponding portions of the struts 710D. For example, on actuation, the hooks can be selectively moved from an engaged position, in load bearing contact with the lugs, to a disengaged position, in which the hooks are disengaged from the lugs, allowing the composite air vehicle 100 to separate from the carrier vehicle 500C.

Referring again to FIG. 2, the launch system 10 can be operated according to a first operating method delivering the payload vehicle 200 to a predetermined altitude, for example the desired altitude H.

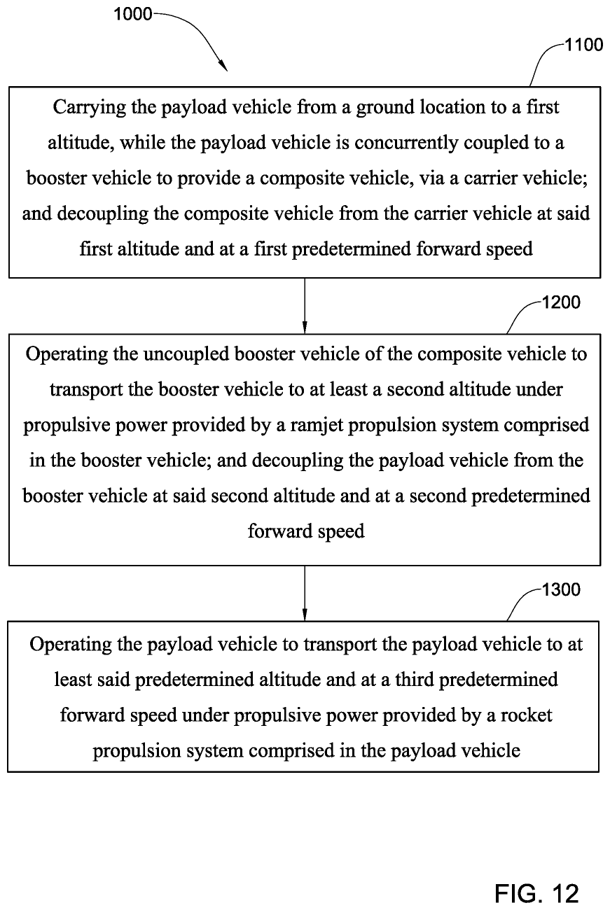

Referring also to FIG. 12, a first example of such a method, generally designated with reference numeral 1000, for example comprises the following steps:
Step 1100—first (subsonic/transonic/low supersonic) phase;
Step 1200—second (supersonic/hypersonic) phase;
Step 1300—third (airless) phase.

Step 1100 comprises carrying the payload vehicle 200 from a ground location GL to a first altitude H1 and at a first predetermined forward speed V_{CA}, while the payload vehicle 200 is concurrently coupled to the booster vehicle 300 (to provide the composite vehicle 100), via the carrier vehicle 500. For example, the launch system 10, with the composite vehicle 100 coupled to the carrier vehicle 500 via the second coupling system 700 (of the first example thereof, or alternatively via the second coupling system 700A, 700B, or 700C of the examples of FIGS. 8, 9, 10, respectively) takes off from a runway at ground location GL in a conventional manner, and climbs to altitude H1 with a forward speed of V_{CA} also in the conventional manner, under the power of the conventional propulsion system 580. Thereafter, the composite vehicle 100 is decoupled from the carrier vehicle 500 at the first altitude H1 and at a first predetermined forward speed V_{CA}. In at least this example, the minimum value of forward speed V_{CA} is the minimum forward speed at which the ramjet propulsion system 530 can provide a minimum and sustainable thrust for enabling acceleration and climb of the composite vehicle 100.

Thus, if the conditions at the first altitude H1 and at the first predetermined forward speed V_{CA} are sufficient for enabling the ramjet propulsion system 530 to operate to generate thrust, in particular sufficient thrust to enable the composite vehicle 100 to accelerate and climb, the method continues directly to step 1200. For example, such a first altitude H1 can be in the range of 10,000 m to 20,000 m, and forward speed V_{CA} which can be at least Mach 0.5, which allow efficient operation of the propulsion system 580 to provide sufficient thrust to maintain altitude. In such conditions, particularly of forward speed V_{CA}, there can be sufficient associated air compression to enable the ramjet propulsion system 350 to ignite and begin to operate to generate thrust.

While at least some ramjet engines are known in the art to be capable of being started, theoretically, at very low speeds around 200 km/hour, these engines do not tend to generate any significant thrust until airspeeds of about Mach 0.5. Conventionally, ramjet engines operate at optimal or maximum efficiency at Mach No 3 to 5, and can operate up to a maximum Mach number of about 6. On the other hand, scramjets conventionally operate at optimal or maximum efficiency at Mach No 6 to 10, and can operate up to a maximum Mach number of about 12, but are typically more expensive than ramjets, have thrust-to-weight ratios much lower than ramjets (for example in the order of about 2 as compared with for example 30 form Scramjets), and require a much greater forward speed than ramjets to start operating.

Alternatively, in alternative variations of this example in which the carrier vehicle 500 cannot achieve the minimum forward speed for operation of the ramjet propulsion system 350, the composite vehicle 100, in particular the booster vehicle 300, can be operated to maneuver into a controlled dive, after separation from the carrier vehicle 500, to thereby accelerate the speed of the composite vehicle 100, until such a minimum forward speed can be achieved and the ramjet propulsion system 350 can begin to generate sustainable and sufficient thrust to thereby allow the composite vehicle 100 to recover from the dive at a particular saddlepoint altitude, and thereafter begin to climb. Thereafter, the composite vehicle 100 is decoupled from the carrier vehicle 500 at the first altitude H1 and at a first predetermined forward speed V_{CA}. For example, the composite vehicle 100 can be decoupled from carrier vehicle 500 at an altitude higher than first altitude H1, such that the aforesaid saddlepoint altitude occurs at the first altitude H1.

In examples in which the carrier vehicle 500 is in the form of a booster rocket, for example as in the example of FIG. 11, the launch system 10 takes off vertically, and at the first altitude H1 the composite vehicle 100 disengages from the carrier rocket 500C.

In any case, once the composite vehicle 100 is uncoupled with respect to the respective carrier vehicle 500, each one continues along its trajectory—the composite vehicle proceeds to step 1200, while the carrier vehicle 500 can return and land on a suitable runway, for example at the ground location GL, in examples in which the carrier vehicle 500 is an aircraft. In other examples in which the carrier vehicle 500 is a rocket booster, the carrier vehicle 500 can be recovered, for example via parachute, or discarded.

Thus, in the first (subsonic/transonic/low supersonic) phase—Step 1100—the propulsion to the first altitude H1 can be carried out using the optimal propulsion system for these conditions, i.e., based on turbojet or turbofan engine systems, that typically have a specific impulse I_{SP} of between 3,000/sec to 5,000/sec or more, and aerodynamic lift generating wings provide lift to the launch system 10 in an efficient and cost-effective manner in the corresponding flight envelope.

In examples in which the carrier vehicle 500 is a subsonic aircraft, for example a subsonic turbofan aircraft as are well known in the art, the carrier vehicle 500 can provide a high subsonic forward speed, for example Mach 0.85.

In other examples, in which the carrier vehicle 500 is a supersonic aircraft, for example as are well known in the art, or in which the carrier vehicle 500 is a rocket booster, the carrier vehicle 500 can provide a low supersonic forward speed, for example Mach 1.5, for more efficient ignition and operation of the ramjet propulsion system 350.

In the next Step 1200, the uncoupled booster vehicle 300 of the composite vehicle 100 is operated to transport the booster vehicle 300 to at least the second altitude H2 under propulsive power provided by the ramjet propulsion system 350 comprised in the booster vehicle 300. As the Mach number of the composite vehicle 100 increases past Mach 1 and up to about Mach 6, the efficiency and thrust output of the ramjet propulsion system 350 increase, further facilitating acceleration and climb of the composite vehicle 100. Once the second altitude H2 and a second predetermined forward speed V_{PV} is achieved by the composite vehicle 100, the payload vehicle 200 is decoupled with respect to the booster vehicle 300.

Once the payload vehicle 200 is uncoupled with respect to the booster vehicle 300, each one continues along its trajectory—the payload vehicle 200 proceeds to step 1300, while the booster vehicle 300 can return and land on a suitable runway, for example at the ground location GL, in a conventional horizontal controlled landing or by parachute, for example.

Thus, in the second (supersonic/hypersonic) phase—Step 1200—the propulsion to the second altitude H2 is carried out using the optimal propulsion system for these conditions, i.e., based on ramjet engine systems, that typically have a specific impulse I_{SP} of between 1,200/sec to 2,200/sec or more, and aerodynamic lift generating wings provide lift to the composite vehicle 100 in an efficient and cost-effective manner in the corresponding flight envelope.

In the next Step 1300 the payload vehicle 200 is operated to transport the payload vehicle 200 to at least the predetermined or desired altitude H and at a third predetermined forward speed V_{P} under propulsive power provided by the rocket propulsion system 250 comprised in the payload vehicle 200. Depending on the mission for the payload P, the forward speed V_{P} can be orbital velocity, or, orbital velocity at a particular orbital altitude, or, escape velocity, sufficient for the payload P to obtain sub orbital trajectory, or, orbital trajectory at a particular orbital altitude, or, escape the earth's gravitational pull, respectively.

Optionally, the payload P can be detached from the payload vehicle 200, or can be maintained attached thereto.

The payload P can of course comprise any suitable or desired cargo—for example one or more satellites—for example communication satellites.

Thus, in the third (airless) phase—Step 1300—the propulsion to the desired altitude H is carried out using the optimal propulsion system for these conditions, i.e., based on rocket engine systems, that typically have a specific impulse I_{SP} of between 300/sec to 400/sec or more.

In at least one implementation of the above examples, the payload vehicle 200 can be configured with an all-up weight of 7664 Kg, including a payload weight of 450 Kg for the payload P, and the at least one rocket engine 260 is configured for delivering the payload vehicle 200 from a second altitude H2 of 37,000 m to desired altitude H of 151,000 m. In this implementation, or in at least one other implementation of the above examples, the booster vehicle 300 can be configured with an all-up weight of 1475 Kg, and the at least one ramjet engine 360 is configured for delivering the composite vehicle 100 from a first altitude H1 of 10,700 m to a second altitude H2 of 37,000 m.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A composite vehicle comprising:
a payload vehicle configured for powered spaceflight at least in a space medium, comprising a rocket driven propulsion system;
a booster vehicle configured for powered supersonic/hypersonic aerodynamic flight, comprising a ramjet propulsion system, and configured for transporting the composite vehicle between a first altitude and a second altitude under propulsive power provided by said ramjet propulsion system;
a first coupling system for selectively coupling and decoupling the payload vehicle with respect to the booster vehicle.

2. The composite vehicle according to claim 1, wherein said ramjet propulsion system comprises at least one of: a pure ramjet engine; a solid fuel integrated rocket ramjet engine (SFIRR); a scramjet engine; a dual mode ramjet/scramjet (DMRJ).

3. The composite vehicle according to any one of claims 1 to 2, wherein said booster vehicle has an absence of a turbojet-based propulsion system or a turbofan-based propulsion system.

4. The composite vehicle according to any one of claims 1 to 3, wherein the booster vehicle comprises an aerodynamic wing system configured for providing lift, stability and control to at least the composite vehicle at least at supersonic/transonic conditions between the first altitude and the second altitude.

5. The composite vehicle according to claim 4, wherein said aerodynamic wing system comprises a delta wing.

6. The composite vehicle according to claim 4, wherein said aerodynamic wing system comprises any one of: variable geometry wings; double delta wings; swept wings.

7. The composite vehicle according to any one of claims 4 to 6, wherein said aerodynamic wing system comprises a vertical stabilizer arrangement including at least one fin pivotable between a stowed position and a deployed position, wherein in the stowed position in which the at least one fin has a first height dimension, and wherein in the deployed position in which the at least one fin has a second height dimension said second height dimension being greater than said first height dimension.

8. The composite vehicle according to claim 7, wherein in the deployed position the at least one fin is configured for generating stability and control moments to at least the composite vehicle.

9. The composite vehicle according to any one of claims 7 to 8, wherein said booster vehicle comprises a fuselage, and said at least one fin is pivotably mounted to said fuselage.

10. The composite vehicle according to any one of claims 7 to 8, wherein said booster vehicle comprises said aerodynamic wing system, and said at least one fin is pivotably mounted to said aerodynamic wing system.

11. The composite vehicle according to any one of claims 4 to 6, wherein said aerodynamic wing system comprises a vertical stabilizer arrangement including at least one fin fixedly mounted to the booster vehicle.

12. The composite vehicle according to any one of claims 1 to 11, wherein said rocket propulsion system comprises at least one of: a solid fuel rocket engine; a liquid fuel rocket engine.

13. The composite vehicle according to any one of claims 1 to 12, wherein said payload vehicle has an absence of any one of: a ramjet based propulsion system; a turbojet based propulsion system; a turbofan based propulsion system.

14. The composite vehicle according to any one of claims 1 to 13, wherein said payload vehicle comprises a payload vehicle payload bay configured for accommodating therein a payload.

15. The composite vehicle according to any one of claims 1 to 13, wherein said first coupling system is configured for coupling the payload vehicle with the booster vehicle in longitudinal stacked arrangement, in which at least a forward part of the payload vehicle is longitudinally forward with respect to the booster vehicle.

16. The composite vehicle according to any one of claims 1 to 13, wherein said first coupling system is configured for coupling the payload vehicle with the booster vehicle in transverse stacked arrangement, in which at least a first part of the payload vehicle is in transverse overlying relationship with respect to the booster vehicle.

17. The composite vehicle according to any one of claims 1 to 13, wherein said booster vehicle comprises a booster vehicle payload bay, and wherein said first coupling system is configured for coupling the payload vehicle with respect to the booster vehicle payload bay.

18. The composite vehicle according to any one of claims 1 to 17, wherein the payload vehicle is configured for transporting the composite vehicle at least between the second altitude and a desired altitude under propulsive power provided by said rocket propulsion system, the desired altitude being higher than the second altitude.

19. The composite vehicle according to any one of claims 1 to 18, wherein said first altitude is the range between 10,000 m and 20,000 m.

20. The composite vehicle according to any one of claims 1 to 19, wherein said second altitude is the range between 30,000 m and 40,000 m.

21. The composite vehicle according to any one of claims 18 to 20, wherein said desired altitude is greater than 40,000 m.

22. A launch system, comprising:
the composite vehicle as defined in any one of claims 1 to 21;
a carrier vehicle configured at least for powered subsonic/transonic/supersonic aerodynamic flight, and configured for transporting said composite vehicle to at least said first altitude from a ground location;
a second coupling system for selectively coupling and decoupling the composite vehicle with respect to the carrier aircraft.

23. The launch system according to claim 22, wherein said carrier vehicle is a subsonic aircraft or a supersonic aircraft.

24. The launch system according to claim 21 or claim 22, wherein said second coupling system is configured for coupling the composite vehicle with the carrier vehicle in transverse stacked arrangement, in which the carrier vehicle is in at least partial transverse overlying relationship with respect to the composite vehicle.

25. The launch system according to claim 21 or claim 22, wherein said second coupling system is configured for coupling the composite vehicle with the carrier vehicle in said transverse stacked arrangement, in which the carrier vehicle comprises a carrier aircraft fuselage and the second coupling system is configured for selectively coupling and decoupling the composite vehicle directly with respect to a lower portion of the carrier aircraft fuselage.

26. The launch system according to claim 25, wherein the composite air vehicle has a height dimension, when coupled to the carrier vehicle, less than the fuselage ground clearance of the carrier vehicle.

27. The launch system according to claim 26, wherein said carrier vehicle is a Boeing 747 type aircraft.

28. The launch system according to claim 21 or claim 22, wherein said second coupling system is in the form of a wing pylon affixed to a port wing or a starboard wing of the carrier vehicle, and configured for coupling the composite vehicle with the carrier vehicle via the wing pylon.

29. The launch system according to claim 28, wherein said carrier vehicle is a Boeing 747 type aircraft, and said wing pylon is mounted to the port wing thereof at attached to anchor points on the underside of the port wing.

30. The launch system according to claim 21 or claim 22, wherein the carrier vehicle comprises two fuselages, each having an outboard wing, and further comprising an interconnecting wing interconnecting the two fuselages, and wherein said second coupling system is in the form of a wing pylon affixed to the interconnecting wing, and configured for coupling the composite vehicle with the carrier aircraft via the wing pylon.

31. The launch system according to claim 30, wherein said second coupling system is configured for coupling the composite vehicle with the carrier aircraft in transverse stacked arrangement, in which the composite vehicle is in at least partial transverse overlying relationship with respect to the carrier aircraft.

32. The launch system according to claim 21 or claim 22, wherein said second coupling system is configured for coupling the composite vehicle with the carrier vehicle in said transverse stacked arrangement, in which the carrier vehicle comprises a carrier aircraft fuselage and the second coupling system is configured for selectively coupling and decoupling the composite vehicle directly with respect to an upper portion of the carrier aircraft fuselage.

33. The launch system according to claim 21, wherein said carrier vehicle is in the form of a rocket booster, configured for propelling the composite vehicle to at least said first altitude from the ground location.

34. The launch vehicle according to claim 33, wherein the second coupling system is configured for coupling the composite vehicle with the carrier vehicle in transverse stacked arrangement, in which the carrier vehicle comprises a booster rocket body and the second coupling system is configured for selectively coupling and decoupling the composite vehicle directly with respect to a side portion of the booster rocket body.

35. A method for delivering a payload vehicle to a predetermined altitude, comprising:
(a) carrying the payload vehicle from a ground location to a first altitude via a carrier vehicle, while the payload vehicle is concurrently coupled to a booster vehicle to provide a composite vehicle; and decoupling the composite vehicle from the carrier vehicle at said first altitude and at a first predetermined forward speed;
(b) operating the uncoupled booster vehicle of the composite vehicle to transport the booster vehicle to at least a second altitude under propulsive power provided by a ramjet propulsion system comprised in the booster vehicle; and decoupling the payload vehicle from the booster vehicle at said second altitude and at a second predetermined forward speed;
(c) operating the payload vehicle to transport the payload vehicle to at least said predetermined altitude and at a third predetermined forward speed under propulsive power provided by a rocket propulsion system comprised in the payload vehicle.

36. The method according to claim 35, wherein the payload vehicle, booster vehicle and composite vehicle are as respectively defined in any one of claims 1 to 21.

37. The method according to claim 35 or claim 36, wherein the carrier vehicle comprised in the launch system is as defined in any one of claims 21 to 34.

38. The method according to any one of claims 35 to 37, wherein said first altitude is the range between 10,000 m and 20,000 m.

39. The method according to any one of claims 35 to 38, wherein said second altitude is the range between 30,000 m and 40,000 m.

40. The method according to any one of claims 35 to 39, wherein said desired altitude is greater than 40,000 m.
